(19) United States
(12) Patent Application Publication
(10) Pub. No.: US 2024/0053567 A1
(43) Pub. Date: Feb. 15, 2024

(54) METHOD AND APPARATUS FOR MANUFACTURING COLORED OPTICAL FIBER

(71) Applicant: SUMITOMO ELECTRIC INDUSTRIES, LTD., Osaka-shi, Osaka (JP)

(72) Inventor: Hiroshi KOHDA, Osaka-shi, Osaka (JP)

(73) Assignee: SUMITOMO ELECTRIC INDUSTRIES, LTD., Osaka-shi, Osaka (JP)

(21) Appl. No.: 18/039,330

(22) PCT Filed: Nov. 29, 2021
(86) PCT No.: PCT/JP2021/043626

§ 371 Date: May 30, 2023

(30) Foreign Application Priority Data
Nov. 30, 2020 (JP) 2020-197905

(51) Int. Cl. G02B 6/44; G01N 21/952; G01N 21/88; C03B 37/025

(52) U.S. Cl. CPC G02B 6/4482; G01N 21/952; G01N 21/8851; C03B 37/0253; G01N 2021/8854

(57) ABSTRACT

A method for manufacturing a colored optical fiber includes: a step of feeding colored resin into a die; a step of causing a coated optical fiber to pass through the inside of the die and applying the colored resin to a periphery of the coated optical fiber to form a colored optical fiber including a colored layer; a step of detecting a color of the colored layer; and a step of determining whether the detected color is good or bad.

### TECHNICAL FIELD

The present disclosure relates to a method and an apparatus for manufacturing a colored optical fiber.

The present application claims priority based on Japanese Patent Application No. 2020-197905 filed on Nov. 30, 2020, the entire content of which is incorporated herein by reference.

### BACKGROUND ART

Patent Literature 1 discloses a defect detection apparatus that can detect a defect of a colored layer in a colored coated optical fiber.

### CITATION LIST

### Patent Literature

Patent Literature 1: JPH11-281524A

### SUMMARY OF INVENTION

A method for manufacturing a colored optical fiber according to one aspect of the present disclosure includes:
a step of feeding colored resin into a die;
a step of causing a coated optical fiber to pass through the inside of the die and applying the colored resin to a periphery of the coated optical fiber to form a colored optical fiber including a colored layer;
a step of detecting a color of the colored layer; and
a step of determining whether the detected color is good or bad.

An apparatus for manufacturing a colored optical fiber according to one aspect of the present disclosure includes:
a tank that feeds colored resin into a die;
the die through which a coated optical fiber passes such that the colored resin is applied to a periphery of the coated optical fiber;
a sensor that detects a color of a colored layer formed of the colored resin on the periphery of the coated optical fiber; and
a controller that determines whether the color detected by the sensor is good or bad.

### BRIEF DESCRIPTION OF DRAWINGS

FIG. 1 is a schematic configuration diagram showing an apparatus for manufacturing a colored optical fiber according to an embodiment of the present disclosure.

FIG. 2 is a diagram showing a color measuring instrument used in a method for manufacturing a colored optical fiber according to a first embodiment of the present disclosure.

FIG. 3 is a diagram showing an irradiation timing of colored light in the color measuring instrument shown in FIG. 2 and an imaging timing of a camera.

FIG. 4 is a diagram showing a brightness of an image acquired by the camera.

FIG. 5 is a diagram showing a color measuring instrument used in a method for manufacturing a colored optical fiber according to a second embodiment.

FIG. 6 is a diagram showing a color measuring instrument used in a method for manufacturing a colored optical fiber according to a third embodiment.

FIG. 7A is a diagram showing a luminance distribution of an image acquired by the camera.

FIG. 7B is a diagram showing a change in the luminance distribution when colored resin is switched.

### DESCRIPTION OF EMBODIMENTS

### Problems to be Solved by Present Disclosure

To easily distinguish between individual optical fibers, a colored layer may be provided on a surface of each of the optical fibers. In the related art, whether the colored layer is provided or the color of the colored layer is fixed for each of manufacturing facilities of optical fibers, and to change the color of the colored layer, it is necessary to replace or clean a die, a pipe, or the like.

Therefore, an object of the present disclosure is to provide a method and an apparatus for manufacturing a colored optical fiber capable of switching the color of the colored layer.

### Description of Embodiment of Present Disclosure

First, aspects of the present disclosure will be described.

A method for manufacturing a colored optical fiber according to one aspect of the present disclosure includes:

(1) a step of feeding colored resin into a die;
a step of causing a coated optical fiber to pass through the inside of the die and applying the colored resin to a periphery of the coated optical fiber to form a colored optical fiber including a colored layer;
a step of detecting a color of the colored layer; and
a step of determining whether the detected color is good or bad.

With such method, when the color of the colored resin is switched, whether the color of the colored layer is defective (for example, colors are mixed) can be appropriately determined. Therefore, the color of the colored resin can be switched without replacing or cleaning a facility for colored resin application. As a result, the color of the colored layer can be flexibly switched depending on stock or demand situations.

(2) In the step of detecting the color, the colored optical fiber may be irradiated with light including RGB components and a part of the light with which the colored optical fiber is irradiated may be detected with a sensor such that a light intensity of each of the RGB components of the light is detected to detect the color, and in the step of determining whether the color is good or bad, whether the color is good or bad may be determined based on the light intensity.

With such method, the determination of whether the color of the colored layer is good or bad can be simply made. The RGB components refer to components of light of R (red), G (green), and B (blue). The light including RGB components refers to including any or all of the components of red, green, and blue. The light intensity of each of the RGB components of the light refers to the light intensity of each of red, green, and blue in the light.

(3) In the step of detecting the color, when the colored optical fiber is irradiated with the RGB components of the light separately to detect a part of each of the RGB components with the sensor, a timing of the irradiation of each of the RGB components may be synchronized with a timing of the detection with the sensor such that a light intensity of each of the RGB components of the light is detected to detect the color, and
in the step of determining whether the color is good or bad, whether the color is good or bad may be determined based on the light intensity.

With such method, the color of the colored layer can be appropriately recognized by detecting each of the RGB components of the light with which the colored optical fiber is irradiated with the sensor.

(4) In the step of detecting the color, the colored optical fiber may be irradiated with white light and a part of the white light may be detected with the sensor such that a light intensity of each of the RGB components of the light is detected to detect the color, and
in the step of determining whether the color is good or bad, whether the color is good or bad may be determined based on the light intensity.

With such method, it is not necessary to use light sources of different colors. Therefore, the color of the colored layer can be appropriately recognized with the simple configuration.

(5) In the step of detecting the color, the colored optical fiber may be irradiated with light including RGB components and transmitted light of the light transmitted through the colored optical fiber may be detected with the sensor such that a light intensity of each of the RGB components of the light is detected to detect the color, and
in the step of determining whether the color is good or bad, whether the color is good or bad may be determined based on the light intensity.

With such method, the color can be measured from a ratio between the light intensities of the transmitted light, and the transparency can also be measured from the light intensities of the transmitted light. As a result, when the color of the colored layer is switched from a transparent color to an opaque color or from an opaque color to a transparent color, whether the color is appropriately switched can be detected.

(6) In the step of detecting the color, the colored optical fiber may be irradiated with light including RGB components and reflected light of the light reflected from the colored optical fiber may be detected with the sensor such that a light intensity of each of the RGB components of the light is detected to detect the color, and
in the step of determining whether the color is good or bad, whether the color is good or bad may be determined based on the light intensity.

With such method, the determination of whether the color of the colored layer is good or bad can be simply made by detecting the light reflected from the colored optical fiber with the sensor.

(7) In the step of detecting the color, the sensor that detects a part of the light with which the colored optical fiber is irradiated may be a line camera sensor including a plurality of pixels in a width direction of the colored optical fiber.

The line camera sensor acquires images corresponding to one line (corresponding to a plurality of pixels) at a time. With such method, the measurement frequency can be set to be high by using the line camera sensor, and fine color defects in a longitudinal direction of the colored optical fiber can also be detected.

(8) In the step of detecting the color, the sensor that detects a part of the light with which the colored optical fiber is irradiated may be an area camera sensor including a plurality of pixels in a width direction and a longitudinal direction of the colored optical fiber.

The area camera sensor images the entire field of view at a time. With such method, a color variation in the colored layer can be detected by using the area camera sensor.

(9) In the step of detecting the color, a part of the light with which the colored optical fiber is irradiated may be detected in three directions with the sensor.

With such method, a defective state where the color is discontinuous can be detected at any position in the peripheral direction.

(10) Before the step of feeding the colored resin into the die,
the method may further include a step of forming a glass fiber by drawing an optical fiber preform while heating the optical fiber preform and
a step of applying primary resin to a periphery of the glass fiber to form the coated optical fiber including a primary resin layer,
the step of feeding the colored resin into the die may include
a step of feeding first colored resin used as secondary resin into the die from a tank filled with the first colored resin and applying the first colored resin to a periphery of the primary resin layer to form a secondary resin layer and
a step of feeding second colored resin having a color different from the color of the first colored resin into the die from a tank filled with the second colored resin and applying the second colored resin to the periphery of the primary resin layer to form a secondary resin layer,
in the step of detecting the color, a change of the color of the secondary resin layer from the color of the first colored resin to the color of the second colored resin may be detected, and
in the step of determining whether the color is good or bad, when it is determined that the change of the color satisfies a predetermined condition, the colored optical fiber may start to be wound up as a non-defective product.

It is preferable to perform the above-described manufacturing method in a step of drawing an optical fiber.

An apparatus for manufacturing a colored optical fiber according to one aspect of the present disclosure includes:
(11) a tank that feeds colored resin into a die;
a die through which a coated optical fiber passes such that the colored resin is applied to a periphery of the coated optical fiber;
a sensor that detects a color of a colored layer formed of the colored resin on the periphery of the coated optical fiber; and
a controller that determines whether the color detected by the sensor is good or bad.

With such configuration, whether the color is good or bad can be determined when the color of the colored layer is switched. Therefore, the color of the colored layer can be flexibly switched depending on stock or demand situations without replacing or cleaning a facility for colored resin application.

### Effects of Invention

According to the present disclosure, it is possible to provide a method and an apparatus for manufacturing a colored optical fiber capable of switching the color of the colored layer.

### Details of Embodiment of Present Disclosure

Specific examples of a method and an apparatus for manufacturing a colored optical fiber according to an embodiment of the present disclosure will be described with reference to the drawings. The present disclosure is not limited to the examples and is intended to include any modifications within the scope and meaning equivalent to the terms of the claims.

A coated optical fiber used in the method for manufacturing the colored optical fiber according to the embodiment includes a primary resin layer that is formed by applying primary resin to a glass fiber formed by drawing an optical fiber preform in a drawing step. The glass fiber is formed of, for example, a core and a cladding of fused silica. In a coating step following the drawing step, as a coating layer, for example, a primary resin layer and a secondary resin layer are formed in the periphery of the optical fiber. In the method for manufacturing the colored optical fiber according to the embodiment, a secondary resin layer (hereinafter, referred to as a colored resin) including a color pigment is used. By forming the secondary resin layer on the periphery of primary resin layer, the colored optical fiber is manufactured. By changing the color of the colored resin used in the secondary resin layer, it is easy to distinguish between the colored optical fibers manufactured as described above.

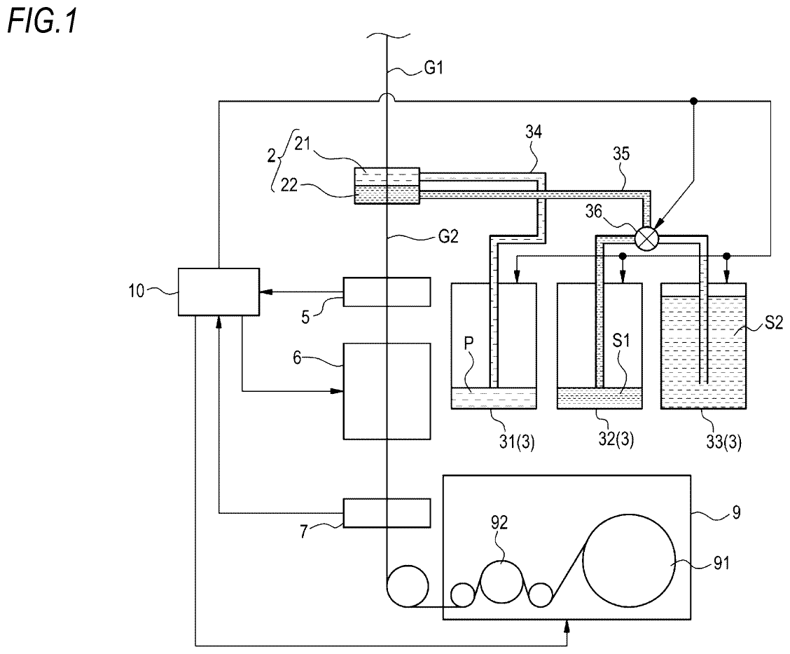

FIG. 1 is a schematic configuration diagram showing the apparatus for manufacturing the colored optical fiber according to the embodiment. As shown in FIG. 1, a manufacturing apparatus 1 for manufacturing a colored optical fiber G2 includes a resin application die 2, a resin tank 3, a color measuring instrument 5, an ultraviolet irradiator 6, an outer diameter measuring instrument 7, a winding-up machine 9, and a controller 10. G1 in FIG. 1 represents a glass fiber G1 that is obtained by heating and fusing the optical fiber preform in a drawing device (not shown).

The resin application die 2 is a die through which the glass fiber G1 passes such that coating resin is applied to the periphery of the glass fiber G1. The resin application die 2 includes: a primary die 21 where primary resin is applied to the periphery of the glass fiber G1 to form a primary resin layer; and a secondary die 22 where secondary resin formed of colored resin is applied to the periphery of the primary resin layer to form a secondary resin layer. The primary resin layer is formed on the periphery of the glass fiber G1 by the primary die 21, and the secondary resin layer is formed on the periphery of the primary resin layer by the secondary die 22. As a result, the colored optical fiber G2 is obtained.

In the embodiment, the primary resin and the secondary resin are applied using the single resin application die 2. However, the present disclosure is not limited thereto. The primary resin and the secondary resin may be applied using separate dies.

The resin tank 3 is a tank that feeds the coating resin to the resin application die 2. The resin tank 3 includes: a primary resin tank 31 that feeds primary resin P to the primary die 21; and secondary resin tanks 32 and 33 that feed secondary resins S1 and S2 to the secondary die 22. The secondary resin S1 contained in the secondary resin tank 32 and the secondary resin S2 contained in the secondary resin tank 33 are colored resins having different colors. As the primary resin P and the secondary resins S1 and S2, for example, ultraviolet curable resin such as urethane acrylate resin is used.

The primary resin tank 31 is connected to the primary die 21 through a supply pipe 34. The secondary resin tanks 32 and 33 are connected to the secondary die 22 through a supply pipe 35. As the secondary resin that is fed to the secondary die 22 through the supply pipe 35, any of the secondary resins S1 and S2 can be selected by controlling a switching valve 36. The primary resin tank 31, the secondary resin tanks 32 and 33, and the switching valve 36 are connected to the controller 10. The number of secondary resin tanks that can be connected to the secondary die 22 through the supply pipe 35 is not limited to two including the secondary resin tanks 32 and 33. For example, three or more secondary resin tanks may be connected. Here, any of three or more colored resins having different colors can be selected by controlling the switching valve 36.

The color measuring instrument 5 is an instrument that detects the color of the colored resin of the secondary resin layer formed on the periphery of coated optical fiber to which the primary resin is applied. As the color measuring instrument 5, a measuring instrument such as an optical sensor, an image sensor, an area camera (area camera sensor), or a line camera (line camera sensor) is used. The color measuring instrument 5 is connected to the controller 10 and transmits data regarding the detected colored resin to the controller 10.

The ultraviolet irradiator 6 is an instrument that irradiates the primary resin and the secondary resin applied to the glass fiber G1 with ultraviolet light to cure the primary resin and the secondary resin. The ultraviolet irradiator 6 is connected to the controller 10.

The outer diameter measuring instrument 7 is an instrument that measures the outer diameter of the colored optical fiber G2 where the primary resin layer and the secondary resin layer are formed. The outer diameter measuring instrument 7 measures the outer diameter of the colored optical fiber G2, for example, by irradiation of laser light from the side of the colored optical fiber G2. The outer diameter measuring instrument 7 is connected to the controller 10 and transmits the measurement result to the controller 10.

The winding-up machine 9 winds the manufactured colored optical fiber G2 up around a winding-up bobbin 91. The colored optical fiber G2 passes through a capstan 92 to be wound up by the winding-up machine 9 at a constant tension. The winding-up machine 9 is connected to the controller 10.

The controller 10 determines whether the color of the secondary resin is good or bad based on the data regarding the colored resin transmitted from the color measuring instrument 5. The determination of whether or the color is good or bad refers to determination of whether the secondary resin layer is formed with a color of a predetermined colored resin fed from the secondary resin tanks 32 and 33 or the like. The controller 10 controls the irradiation time or the irradiation intensity of the ultraviolet irradiator 6, the winding-up speed of the winding-up machine 9, and the like based on the data transmitted from the color measuring instrument 5, the outer diameter measuring instrument 7, and the like.

Next, the method for manufacturing the colored optical fiber according to the embodiment will be described. The method for manufacturing the colored optical fiber according to the embodiment is a method for manufacturing the colored optical fiber G2 using the manufacturing apparatus 1 shown in FIG. 1.

### First Embodiment

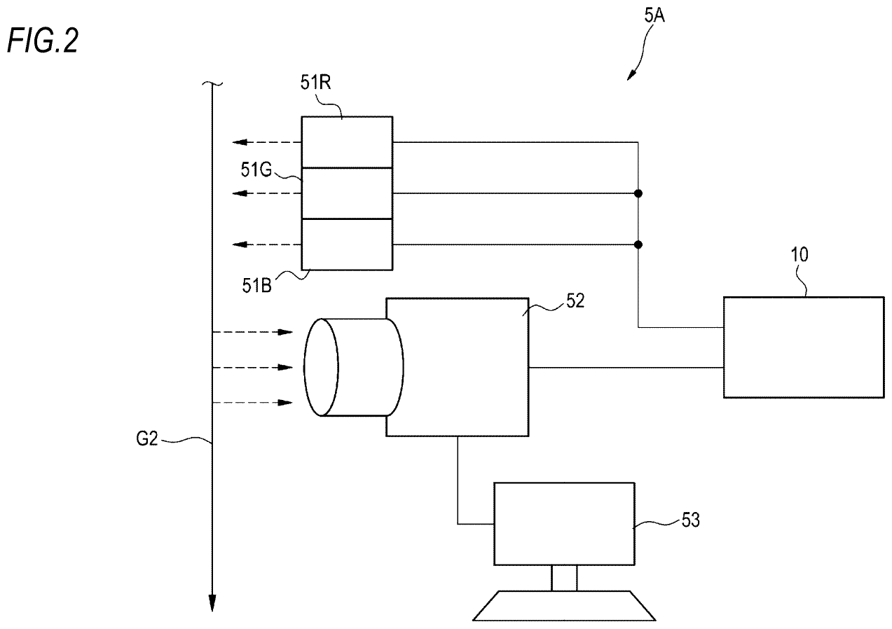

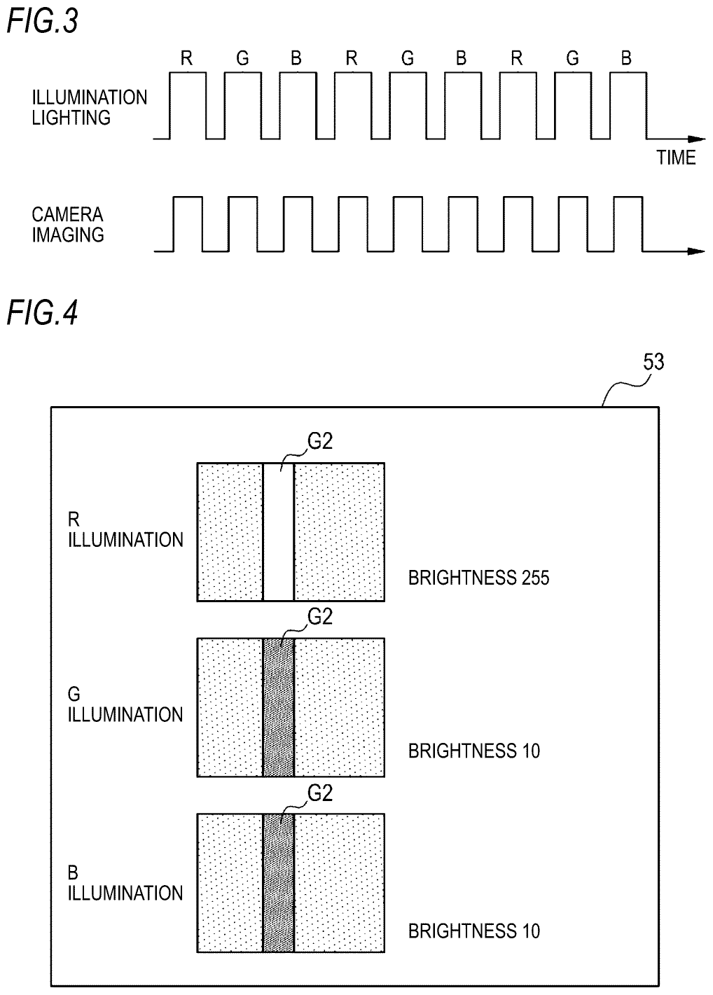

A method for manufacturing a colored optical fiber according to a first embodiment will be described below with reference to FIGS. 2 to 4. FIG. 2 is a diagram showing a color measuring instrument 5A used in the method for manufacturing the colored optical fiber according to the first embodiment. FIG. 3 is a diagram showing an irradiation timing of colored light in the color measuring instrument 5A and an imaging timing of a camera. FIG. 4 is a diagram showing a brightness of an image acquired by the camera. As shown in FIG. 2, the color measuring instrument 5A includes a red illumination 51R, a green illumination 51G, a blue illumination 51B, a camera 52, and an image display device 53. In the following description, the red illumination 51R, the green illumination 51G, and the blue illumination 51B will also be collectively referred to as the RGB illuminations. As the RGB illuminations 51R, 51G, and 51B, for example, LEDs that emit the respective colored light components of RGB are used. As the camera 52, for example, a monochrome area camera is used. The camera 52 as the area camera includes, for example, a two-dimensional imaging element including a plurality of pixels in a width direction and a longitudinal direction of the colored optical fiber G2. As the image display device 53, for example, a personal computer is used. The RGB illuminations 51R, 51G, and 51B and the camera 52 are connected to the controller 10.

(Drawing Step)

First, the glass fiber G1 is formed by drawing the optical fiber preform while heating the optical fiber preform using a drawing device (not shown).

(Coating Step)

Next, the controller 10 controls the primary resin tank 31 to feed the primary resin P from the primary resin tank 31 to the primary die 21 through the supply pipe 34. The primary die 21 applies the primary resin P fed from the primary resin tank 31 to the periphery of the glass fiber G1 that is passing through the inside of the primary die 21.

Next, the controller 10 switches the switching valve 36 to select, for example, the secondary resin S1 of the secondary resin tank 32 and to feed the secondary resin S1 from the secondary resin tank 32 to the secondary die 22 through the supply pipe 35. For example, when the secondary resin tank 32 contains the red colored resin as the secondary resin S1, the red secondary resin S1 is fed from the secondary resin tank 32 to the secondary die 22. The secondary die 22 applies the red secondary resin S1 fed from the secondary resin tank 32 to the periphery of the primary resin P of the coated optical fiber that is passing through the inside of the secondary die 22.

As a result, the red colored optical fiber G2 where the periphery of the glass fiber G1 is coated with the primary resin P and the red secondary resin S1 is manufactured.

(First Inspection Step)

Next, in the color measuring instrument 5A, the controller 10 causes each of the red illumination 51R, the green illumination 51G, and the blue illumination 51B to irradiate the manufactured colored optical fiber G2 with each of the colored light components. The controller 10 irradiates the colored optical fiber G2 with the RGB components from the red illumination 51R, the green illumination 51G, and the blue illumination 51B and images reflected light reflected from the colored optical fiber G2 with the camera 52.

As shown in FIG. 3, the controller 10 lights the red illumination 51R, the green illumination 51G, and the blue illumination 51B at different timings in order. The controller images the reflected light reflected from the colored optical fiber G2 with the camera 52 in synchronization with the lighting timings of the red illumination 51R, the green illumination 51G, and the blue illumination 51B.

The controller 10 processes each of the images of the red illumination 51R, the green illumination 51G, and the blue illumination 51B acquired by the camera 52 (monochrome area camera) to detect the brightness (an example of the light intensity of the light) of the reflected light reflected from the colored optical fiber G2 in each of the images. The controller 10 determines the color of the secondary resin of the colored optical fiber G2 based on the brightness of each of the RGB components of the detected reflected light. The color is determined by determining whether the brightness of each of the RGB components of the reflected light from the colored optical fiber G2 in the red illumination 51R, the green illumination 51G, and the blue illumination 51B satisfies a threshold condition. As in the example, when the red secondary resin S1 is fed from the secondary resin tank 32 to the secondary die 22, the controller 10 determines the color of the secondary resin as red based on the brightness of each of the RGB components of the reflected light. When the color of the colored resin fed from the secondary resin tank 32 to the secondary die 22 is the same as the color of the secondary resin determined based on the brightness of the reflected light of the colored optical fiber G2, the controller 10 determines the color of the colored optical fiber G2 to be “Good”.

As shown in FIG. 4, each of the images acquired by the camera 52 and the brightness of the reflected light detected in each of the images may be displayed by the image display device 53. Regarding the brightness of the reflected light reflected from the red colored optical fiber G2, the brightness of the reflected light during the irradiation from the red illumination 51R is high (for example, a brightness of 255), and the brightness of the reflected light during the irradiation from the green illumination 51G and the blue illumination 51B is low (for example, a brightness of 10). The controller 10 determines whether each of the brightness values “255” and “10” satisfies the threshold condition to determine the color of the secondary resin.

(Curing Step)

Next, the controller 10 controls the ultraviolet irradiator 6 to irradiate the colored optical fiber G2 with ultraviolet light such that the primary resin P and the secondary resin S1 are cured.

(Secondary Inspection Step)

Next, the outer diameter measuring instrument 7 measures the outer diameter of the colored optical fiber G2 where the coating layer is cured. The outer diameter measuring instrument 7 transmits the measured outer diameter value to the controller 10.

(Winding-Up Step)

Finally, the controller 10 controls the winding-up machine 9 based on the data transmitted from the color measuring instrument 5A, the outer diameter measuring instrument 7, and the like to wind up the red colored optical fiber G2 around the winding-up bobbin 91 at a predetermined linear velocity while applying a predetermined tension to the red colored optical fiber G2.

Next, after manufacturing the red colored optical fiber G2 as described above, for example, a case of manufacturing the yellow colored optical fiber G2 will be described.

In the coating step, the controller 10 switches the switching valve 36 to change the secondary resin tank from which the secondary resin is fed into the secondary die 22. The controller 10 selects, for example, the secondary resin tank 33 containing the yellow colored resin to feed the secondary resin S2 as the yellow colored resin from the secondary resin tank 33 to the secondary die 22 through the supply pipe 35. The secondary die 22 applies the yellow secondary resin S2 fed from the secondary resin tank 33 to the periphery of the primary resin P of the coated optical fiber that is passing through the inside of the secondary die 22.

Incidentally, when the secondary resin tank that feeds the secondary resin is switched from the secondary resin tank 32 to the secondary resin tank 33 by the switching valve 36, the red secondary resin S1 fed from the secondary resin tank 32 remains in the supply pipe 35 between the switching valve 36 and the secondary die 22. Therefore, the yellow secondary resin S2 is not supplied to the secondary die 22 immediately. Accordingly, immediately after switching the secondary resin tank, the red secondary resin S1 or mixed resin of the red secondary resin S1 and the yellow secondary resin S2 is supplied to the secondary die 22. The secondary die 22 applies the red secondary resin S1 or the mixed resin of the red secondary resin S1 and the yellow secondary resin S2 to the periphery of the primary resin P of the coated optical fiber that is passing through the inside of the secondary die 22.

Therefore, in the color measurement of the color measuring instrument 5A in the first inspection step, when the switching valve 36 is switched, the controller 10 determines that the color of the secondary resin is not yellow based on the brightness of the reflected light reflected from the colored optical fiber G2 although the controller 10 selects the secondary resin tank 33 containing the yellow secondary resin S2. That is, the controller 10 determines that the brightness of the reflected light does not satisfy the threshold condition predetermined for the yellow colored optical fiber G2, determines that the color of the colored resin fed into the secondary die 22 is different from the color of the secondary resin determined based on the brightness of the reflected light, and determines the color of the colored optical fiber G2 to be “Bad (Defective)”. “The brightness of the reflected light being the threshold or higher” is an example of “the change of the color satisfies the predetermined condition”.

As such, when the switching valve 36 is switched, while the colored resin (secondary resin) in the supply pipe 35 is replaced, the controller 10 determines that the colored optical fiber G2 having a different color from the set color is manufactured. When the colored resin in the supply pipe 35 is completely replaced, the controller 10 determines that the colored optical fiber G2 having the set color of yellow is manufactured, and determines the color of the colored optical fiber G2 to be “Good”.

In the winding-up step, the controller 10 winds up the colored optical fiber G2 of which the color is determined to be “Bad (Defective)” around the winding-up bobbin 91 for a defective product as a defective product, and winds up the yellow colored optical fiber G2 of which the color is determined to be “Good” around the winding-up bobbin 91 for a non-defective product as a non-defective product. This way, the colored optical fiber G2 (defective product) of which the color is determined to be “Bad (Defective)” and the yellow colored optical fiber G2 (non-defective product) of which the color is determined to be “Good” may be wound up around different winding-up bobbins 91, or the colored optical fiber G2 as the defective product and the colored optical fiber G2 as the non-defective product may be wound up continuously around the same winding-up bobbin 91. When the non-defective product and the defective product are wound up continuously around the same winding-up bobbin 91, it is preferable to enable to recognize a winding-up start position of the yellow colored optical fiber G2 that is determined to be a non-defective product.

Since other steps in the manufacturing method after switching the color are the same as those of the above-described manufacturing method, the description thereof will not be repeated.

As described above, the method for manufacturing the colored optical fiber according to the first embodiment includes: a step of feeding colored resin (secondary resins S1 and S2) into a secondary die 22; a step of causing a coated optical fiber to pass through the inside of the secondary die 22 and applying the colored resin to a periphery of the coated optical fiber to form a colored optical fiber G2 including a colored layer; a step of detecting a color of the colored layer of the colored optical fiber G2; and a step of determining whether the detected color of the colored layer is good or bad. With this method, the color of the colored resin supplied to the secondary die 22 can be switched by switching the switching valve 36. Whether the colored optical fiber G2 is appropriately colored with the color of the switched resin (the colored layer is switched from the color defective state to a non-defective state) can be determined by the color measuring instrument 5A. Therefore, when the color of the colored resin applied to the glass fiber G1 is changed, the replacement/cleaning of a facility (a die, a pipe, or the like) for colored resin application is unnecessary. As a result, the color of the colored layer in the colored optical fiber G2 can be flexibly switched depending on stock or demand situations of the colored resin.

In the method for manufacturing the colored optical fiber, in the step of detecting the color, the colored optical fiber G2 is irradiated with each of the RGB components of light and reflected light of each of the RGB components reflected from the colored optical fiber G2 is imaged with the camera 52 such that a brightness (light intensity) of the reflected light is detected. In the step of determining whether the color is good or bad, whether the color of the colored layer is good or bad is determined based on the brightness of the reflected light. With such method, the determination of whether the color is good or bad after switching the color of the colored resin can be simply made using the RGB illuminations 51R, 51G, and 51B and the single camera 52.

In the method for manufacturing the colored optical fiber, in the step of detecting the color, when the colored optical fiber G2 is irradiated with the RGB components from the RGB illuminations 51R, 51G, and 51B in order, a timing of the irradiation of each of the RGB components is synchronized with a timing of the imaging with the camera 52. With such method, the reflected light from the colored optical fiber G2 is imaged with the camera 52 for each of the RGB components. Therefore, the brightness of each of the RGB components of the reflected light can be accurately measured, and whether the color of the colored layer is good or bad can be accurately determined.

In the method for manufacturing the colored optical fiber, before the step of feeding the colored resin into the secondary die 22, the method further includes a step of forming a glass fiber G1 by drawing an optical fiber preform while heating the optical fiber preform and a step of applying primary resin P to a periphery of the glass fiber G1 to form the coated optical fiber including a primary resin layer. The step of feeding the colored resin into the secondary die 22 includes a step of feeding first colored resin used as secondary resin S1 into the secondary die 22 from a secondary resin tank 32 filled with the first colored resin and applying the first colored resin to a periphery of the primary resin layer to form a secondary resin layer and a step of feeding second colored resin having a color different from the color of the first colored resin into the secondary die 22 from a secondary resin tank 33 filled with the second colored resin and applying the second colored resin to the periphery of the primary resin layer to form a secondary resin layer, in the step of detecting the color, a change of the color of the secondary resin layer from the color of the first colored resin to the color of the second colored resin is detected, and in the step of determining whether the color is good or bad, when it is determined that the change of the color satisfies a predetermined condition, the colored optical fiber G2 starts to be wound up as a non-defective product. With such method, the color of the colored layer can be determined based on the predetermined threshold, and the colored optical fiber G2 as a non-defective product that satisfies the threshold condition can be wound up. Therefore, the color of the colored resin can be changed without increasing unnecessary parts that do not become non-defective products.

The manufacturing apparatus 1 for the colored optical fiber includes: secondary resin tanks 32 and 33 that feed colored resin into a secondary die 22; the secondary die 22 through which a coated optical fiber passes such that the colored resin is applied to a periphery of the coated optical fiber; a color measuring instrument 5 (sensor) that detects a color of a colored layer formed of the colored resin on the periphery of the coated optical fiber; and a controller 10 that determines whether the color of the colored layer detected by the color measuring instrument 5 is good or bad. With such configuration, when the color of the colored resin supplied to the secondary die 22 is switched, whether the colored optical fiber G2 is colored with the color of the switched resin (the colored layer is switched from the color defective state to a non-defective state) can be determined by the color measuring instrument 5A. Therefore, when the color of the colored resin applied to the glass fiber G1 is changed, the replacement or cleaning of a facility (a die, a pipe, or the like) for colored resin application is unnecessary. As a result, the color of the colored layer in the colored optical fiber G2 can be flexibly switched depending on stock or demand situations of the colored resin.

In the above-described embodiment, the color measuring instrument 5 is provided between the resin application die 2 and the ultraviolet irradiator 6. However, the present disclosure is not limited thereto. The color measuring instrument 5 may be provided at another position as long as the position is between the resin application die 2 and the winding-up machine 9. Note that the color is changed before and after curing the resin. Therefore, it is necessary to set a threshold for each of states to detect the color.

In the above-described embodiment, the secondary resin that is applied to the periphery of the coated optical fiber to which the primary resin is applied is the colored resin. However, the present disclosure is not limited thereto. For example, the primary resin and the secondary resin may be applied to the periphery of the glass fiber to form a coated optical fiber, and a colored layer formed of a color ink may be formed on the periphery of the secondary resin of the coated optical fiber in a coloring step.

In the above-described embodiment, to reduce the switching time of the colored resin when the switching valve 36 is switched, for example, the position of the switching valve 36 may be further provided at a position close to the secondary die 22. Here, for example, by switching the switching valve 36 during the replacement of the winding-up bobbin 91, the color of the colored resin that is being drawn can be changed while reducing the amount of the colored optical fiber G2 of which the color is determined to be “Bad (Defective)”.

In the above-described embodiment, the switching valve 36 may be switched when a tip of the optical fiber preform is led out. Here, the colored optical fiber G2 of which the color is determined to be “Bad (Defective)” can be used while the linear velocity is increasing, and the colored optical fiber G2 of which the color is determined to be “Good” can start to be wound up around the winding-up bobbin 91 at an initial stage. As a result, the color of the colored resin can be changed while reducing the amount of the colored optical fiber G2 of which the color is determined to be “Bad (Defective)”.

### Second Embodiment

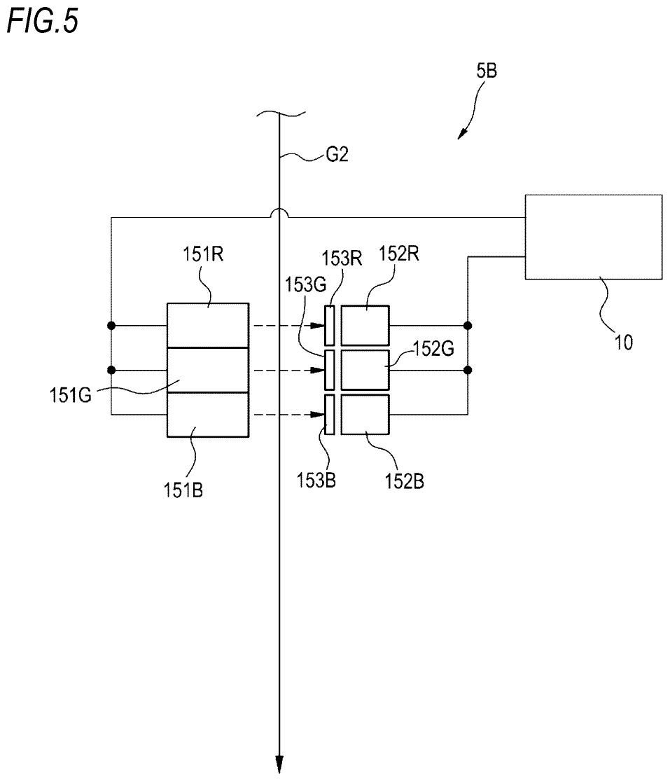

A method for manufacturing a colored optical fiber according to a second embodiment will be described below with reference to FIG. 5. FIG. 5 is a diagram showing a color measuring instrument 5B used in the method for manufacturing the colored optical fiber according to the second embodiment. As shown in FIG. 5, the color measuring instrument 5B includes a red laser source 151R, a green laser source 151G, a blue laser source 151B, a camera for red 152R, a camera for green 152G, and a camera for blue 152B. A red filter 153R through which red laser light can transmit is attached to the camera for red 152R. A green filter 153G through which green laser light can transmit is attached to the camera for green 152G. A blue filter 153B through which blue laser light can transmit is attached to the camera for blue 152B. The red laser source 151R and the camera for red 152R, the green laser source 151G and the camera for green 152G, and the blue laser source 151B and the camera for blue 152B are provided at positions facing each other with respect to the colored optical fiber G2, respectively. Each of the laser sources 151R, 151G, and 151B and each of the cameras 152R, 152G, and 152B are connected to the controller 10.

In the color measurement of the color measuring instrument 5B in the first inspection step, the controller 10 causes each of the red laser source 151R, the green laser source 151G, and the blue laser source 151B to irradiate the colored optical fiber G2 with the colored light. The controller 10 irradiates the colored optical fiber G2 with the RGB components from the red laser source 151R, the green laser source 151G, and the blue laser source 151B and detects the light intensities of the RGB components of the transmitted light transmitted through the colored optical fiber G2 with the camera for red 152R, the camera for green 152G, and the camera for blue 152B, respectively.

The controller 10 determines the color of the secondary resin of the colored optical fiber G2 based on the light intensity of each of the RGB components of the detected transmitted light. The color is determined by determining whether the light intensity of each of the RGB components of the detected transmitted light transmitted through the colored optical fiber G2 in the red laser source 151R, the green laser source 151G, and the blue laser source 151B satisfies a threshold condition. When the controller 10 determines that the light intensity of each of the RGB components of the transmitted light satisfies the predetermined threshold condition, the controller 10 determines that the color of the colored resin fed into the secondary die 22 is the same as the color of the secondary resin determined based on the light intensity of each of the RGB components of the transmitted light, and determines the color of the colored optical fiber G2 to be “Good”. On the other hand, when the controller 10 determines that the light intensity of each of the RGB components of the transmitted light does not satisfy the predetermined threshold condition, the controller 10 determines that the color of the colored resin fed into the secondary die 22 is different from the color of the secondary resin determined based on the light intensity of each of the RGB components of the transmitted light, and determines the color of the colored optical fiber G2 to be “Bad (Defective)”.

As described above, in the method for manufacturing the colored optical fiber according to the second embodiment, in the step of detecting the color, the colored optical fiber G2 is irradiated with each of the RGB components and light intensities of the RGB components transmitted through the colored optical fiber G2 are detected with the cameras 152R, 152G, and 152B corresponding to the respective colored light components, and in the step of determining whether the color is good or bad, whether the color of the colored layer is good or bad is determined based on the light intensity of each of the RGB components of the transmitted light. With such method, the determination of whether the color of the colored layer is good or bad after switching the color of the colored resin can be simply made based on the ratio between the light intensities of the RGB components of the transmitted light. With the method of the second embodiment, the transparency of the colored layer can be measured based on the light intensities of the RGB components of the transmitted light. Therefore, when the color of the colored layer is switched from a transparent color to an opaque color or from an opaque color to a transparent color, whether the color is appropriately switched can be detected. By using a single sensor instead of the cameras 152R, 152G, and 152B (for example, an area camera or a line camera), the processing of camera images can be removed. Therefore, the color measuring instrument 5B with the high-speed and inexpensive configuration can be provided.

In the above-described embodiment, to detect the light intensities of the transmitted light components of the laser sources 151R, 151G, and 151B, the cameras 152R, 152G, and 152B are used. However, the present disclosure is not limited thereto. For example, the light intensities may be detected using a laser detection sensor.

### Third Embodiment

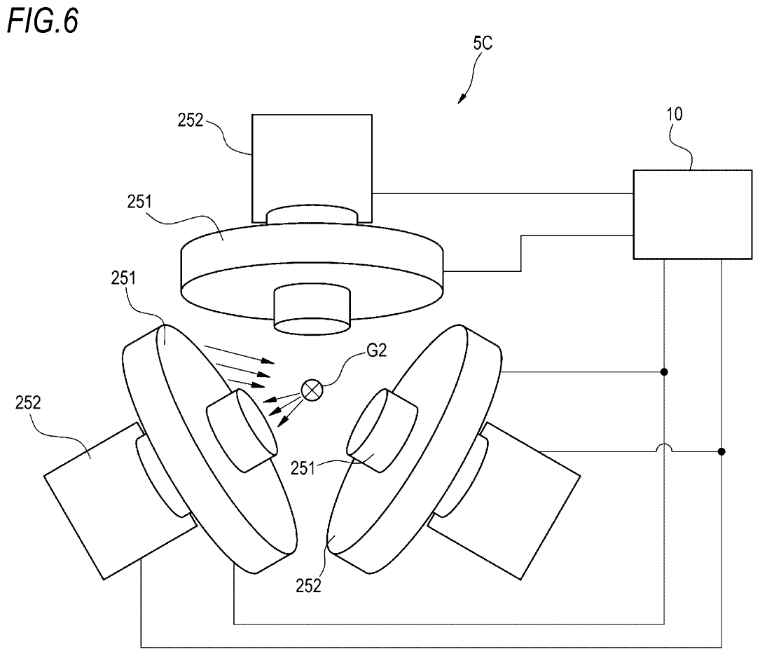

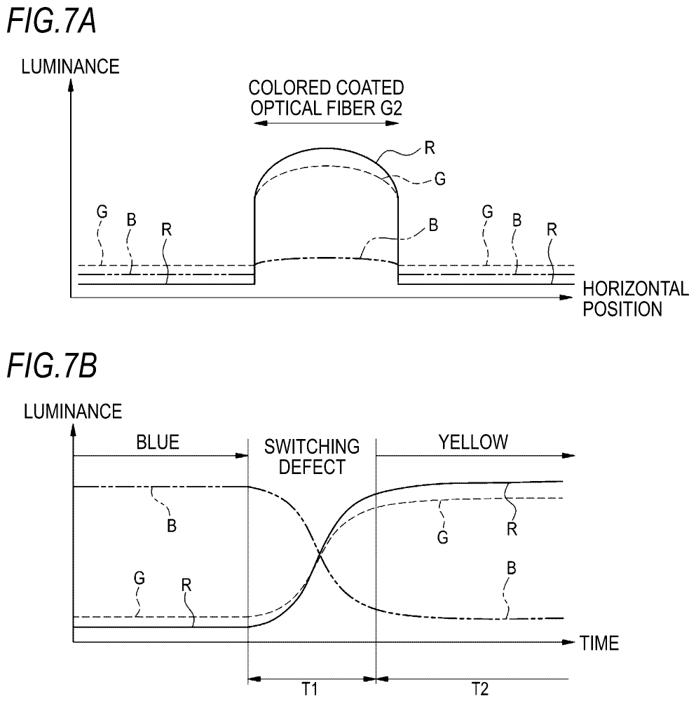

A method for manufacturing a colored optical fiber according to a third embodiment will be described below with reference to FIGS. 6, 7A, and 7B. FIG. 6 is a diagram showing a color measuring instrument 5C used in the method for manufacturing the colored optical fiber according to the third embodiment. FIG. 7A is a diagram showing a luminance distribution of an image acquired by the camera of the color measuring instrument 5C. FIG. 7B is a diagram showing a change in the luminance distribution when colored resin that is applied to a coated optical fiber is switched. As shown in FIG. 6, the color measuring instrument 5C includes three white illuminations 251 and three color cameras 252 that are disposed in three rotationally symmetrical directions to surround the periphery of the colored optical fiber G2. In the embodiment, one white illumination 251 and one color camera 252 are formed to be integrated. As the white illumination 251, for example, a white LED is used. As the color camera 252, for example, a line camera is used. The color camera 252 as the line camera includes, for example, a one-dimensional imaging element including a plurality of pixels in a width direction of the colored optical fiber G2. An imaging interval of the color camera 252 is preferably, for example, 1 kHz or more (1 msec or less). Each of the white illuminations 251 and each of the color cameras 252 are connected to the controller 10.

In the color measurement of the color measuring instrument 5C in the first inspection step, the controller 10 instructs each of the white illuminations 251 to irradiate the colored optical fiber G2 with white light. The controller 10 instructs each of the color cameras 252 to image reflected light reflected from the colored optical fiber G2 during the irradiation from the white illumination 251. The controller 10 processes the image acquired by each of the color cameras 252 (line cameras) to detect RGB luminance values (an example of the light intensity of the light) of the reflected light reflected from the colored optical fiber G2 in each of the images.

The controller 10 determines the color of the secondary resin of the colored optical fiber G2 based on each of the RGB luminance values of the detected reflected light. The color is determined by determining whether each of the RGB luminance values of the reflected light from the colored optical fiber G2 in the white illuminations 251 satisfies a threshold condition. When the controller 10 determines that each of the RGB luminance values of the reflected light satisfies the predetermined threshold condition, the controller 10 determines that the color of the colored resin fed into the secondary die 22 is the same as the color of the secondary resin determined based on each of the RGB luminance values of the reflected light, and determines the color of the colored optical fiber G2 to be “Good”. When the controller 10 determines that each of the RGB luminance values of the reflected light does not satisfy the predetermined threshold condition, the controller 10 determines that the color of the colored resin fed into the secondary die 22 is different from the color of the secondary resin determined based on each of the RGB luminance values of the reflected light, and determines the color of the colored optical fiber G2 to be “Bad (Defective)”.

For example, when the color of the secondary resin of the manufactured colored optical fiber G2 is yellow, as shown in FIG. 7A, regarding the RGB luminance values of the reflected light reflected from the colored optical fiber G2, the luminance values of R (red) and G (green) are detected to be high, and the luminance of B (blue) is detected to be low. When the detected RGB luminance values satisfy a predetermined threshold condition of yellow, the controller 10 determines that the color of the secondary resin is yellow.

Next, for example, when a state where the blue colored optical fiber G2 is manufactured is switched to a state where the yellow colored optical fiber G2 is manufactured, the color measurement of the color measuring instrument 5C will be described.

As described in the first embodiment, when the colored resin (secondary resin) fed from the secondary resin tank is switched by the switching valve 36, a period where the colored resin before the switching and the colored resin before the switching are mixed and supplied to the secondary die 22 is present.

Therefore, when the manufacturing of the blue colored optical fiber G2 is switched to the manufacturing of the yellow colored optical fiber G2 as in the example, the RGB luminance values of the reflected light reflected from the colored optical fiber G2 are unstable in a predetermined period T1 during switching as shown FIG. 7B.

That is, the controller 10 determines that the detected RGB luminance values of the reflected light do not satisfy the threshold condition predetermined for the yellow colored optical fiber G2 in the predetermined period T1, determines that the color of the colored resin fed into the secondary die 22 is different from the color of the secondary resin determined based on the RGB luminance values of the reflected light, and determines the color of the colored optical fiber G2 to be “Bad (Defective)”.

After the predetermined period T1, the RGB luminance values of the reflected light are stable, and when the controller 10 determines that the RGB luminance values of the reflected light satisfy the threshold condition predetermined for the yellow colored optical fiber G2 (period T2), the controller 10 determines that the color of the colored resin fed into the secondary die 22 is the same as the color of the secondary resin determined based on the RGB luminance values of the reflected light, and determines the color of the colored optical fiber G2 to be “Good”.

In the above-described embodiment, the RGB luminance values are measured using the three white illuminations 251 and the three color cameras 252. However, the present disclosure is not limited thereto. For example, the RGB luminance values may be measured using the single white illumination 251 and the single color camera 252.

As described above, in the method for manufacturing the colored optical fiber according to the third embodiment, in the step of detecting the color, the colored optical fiber G2 is irradiated with white light from the white illumination 251 and reflected light of the white light reflected from the colored optical fiber G2 is imaged with the color camera 252 such that RGB luminance values of the reflected light are detected, and in the step of determining whether the color is good or bad, whether the color of the colored layer is good or bad is determined based on the RGB luminance values of the reflected light. With such method, it is not necessary to use light sources of different colors. Therefore, each of the RGB luminance values of the reflected light can be accurately measured with the simple configuration, and whether the color of the colored layer is good or bad can also be accurately determined.

In the method for manufacturing the colored optical fiber, in the step of detecting the color, the colored optical fiber G2 is imaged with the color cameras 252 in the three directions. In such method, the color of the entire periphery of the colored optical fiber G2 can be completely detected by the color cameras 252 disposed in the three directions. Therefore, whether the color of the colored layer is good or bad can be accurately determined. Since the color is imaged in the three directions, a defective state where the color is discontinuous can be detected at any position in the peripheral direction. By using the color cameras 252 as the line cameras capable of high-resolution imaging, small color defects in the longitudinal direction can be detected. Therefore, for example, leakage of discontinuous coloring such as a ring mark applied to the colored optical fiber G2 can also be detected. Although the present disclosure has been described in detail with reference to specific embodiments, it will be apparent to those skilled in the art that various changes and modifications can be made without departing from the spirit and scope of the disclosure. The numbers, positions, shapes, and the like of the components described above are not limited to those of the embodiments and can be changed to numbers, positions, shapes, and the like suitable for implementing the present disclosure.

### REFERENCE SIGNS LIST

1: manufacturing apparatus
2: resin application die
3: resin tank
5 (5A, 5B, 5C): color measuring instrument
6: ultraviolet irradiator
7: outer diameter measuring instrument
9: winding-up machine
10: controller
21: primary die
22: secondary die
31: primary resin tank
32, 33: secondary resin tank
34, 35: supply pipe
36: switching valve
51R: red illumination
51G: green illumination
51B: blue illumination
52: camera
53: image display device
91: winding-up bobbin
92: capstan
151R: red laser source
151G: green laser source
151B: blue laser source
152R: camera for red
152G: camera for green
152B: camera for blue
153R: red filter
153G: green filter
153B: blue filter
251: white illumination
252: color camera
G1: glass fiber
G2: colored optical fiber
P: primary resin
S1, S2: secondary resin

1. A method for manufacturing a colored optical fiber, the method comprising:
a step of feeding colored resin into a die;
a step of causing a coated optical fiber to pass through the inside of the die and applying the colored resin to a periphery of the coated optical fiber to form a colored optical fiber including a colored layer;
a step of detecting a color of the colored layer; and
a step of determining whether the detected color is good or bad.

2. The method for manufacturing a colored optical fiber according to claim 1, wherein
in the step of detecting the color, the colored optical fiber is irradiated with light including RGB components and a part of the light with which the colored optical fiber is irradiated is detected with a sensor such that a light intensity of each of the RGB components of the light is detected to detect the color, and
in the step of determining whether the color is good or bad, whether the color is good or bad is determined based on the light intensity.

3. The method for manufacturing a colored optical fiber according to claim 2, wherein
in the step of detecting the color, when the colored optical fiber is irradiated with the RGB components of the light separately to detect a part of each of the RGB components with the sensor, a timing of the irradiation of each of the RGB components is synchronized with a timing of the detection with the sensor such that a light intensity of each of the RGB components of the light is detected to detect the color, and
in the step of determining whether the color is good or bad, whether the color is good or bad is determined based on the light intensity.

4. The method for manufacturing a colored optical fiber according to claim 2, wherein
in the step of detecting the color, the colored optical fiber is irradiated with white light and a part of the white light is detected with the sensor such that a light intensity of each of the RGB components of the light is detected to detect the color, and
in the step of determining whether the color is good or bad, whether the color is good or bad is determined based on the light intensity.

5. The method for manufacturing a colored optical fiber according to I claim 2, wherein
in the step of detecting the color, the colored optical fiber is irradiated with light including RGB components and transmitted light of the light transmitted through the colored optical fiber is detected with the sensor such that a light intensity of each of the RGB components of the light is detected to detect the color, and
in the step of determining whether the color is good or bad, whether the color is good or bad is determined based on the light intensity.

6. The method for manufacturing a colored optical fiber according to claim 2, wherein
in the step of detecting the color, the colored optical fiber is irradiated with light including RGB components and reflected light of the light reflected from the colored optical fiber is detected with the sensor such that a light intensity of each of the RGB components of the light is detected to detect the color, and
in the step of determining whether the color is good or bad, whether the color is good or bad is determined based on the light intensity.

7. The method for manufacturing a colored optical fiber according to claim 2, wherein
in the step of detecting the color, the sensor that detects a part of the light with which the colored optical fiber is irradiated is a line camera sensor including a plurality of pixels in a width direction of the colored optical fiber.

8. The method for manufacturing a colored optical fiber according to claim 2, wherein
in the step of detecting the color, the sensor that detects a part of the light with which the colored optical fiber is irradiated is an area camera sensor including a plurality of pixels in a width direction and a longitudinal direction of the colored optical fiber.

9. The method for manufacturing a colored optical fiber according to claim 2, wherein
in the step of detecting the color, a part of the light with which the colored optical fiber is irradiated is detected in three directions with the sensor.

10. The method for manufacturing a colored optical fiber according to claim 1, wherein
before the step of feeding the colored resin into the die,
the method further includes a step of forming a glass fiber by drawing an optical fiber preform while heating the optical fiber preform, and
a step of applying primary resin to a periphery of the glass fiber to form the coated optical fiber including a primary resin layer,
the step of feeding the colored resin into the die includes
a step of feeding first colored resin used as secondary resin into the die from a tank filled with the first colored resin and applying the first colored resin to a periphery of the primary resin layer to form a secondary resin layer, and
a step of feeding second colored resin having a color different from the color of the first colored resin into the die from a tank filled with the second colored resin and applying the second colored resin to the periphery of the primary resin layer to form a secondary resin layer,
in the step of detecting the color, a change of the color of the secondary resin layer from the color of the first colored resin to the color of the second colored resin is detected, and
in the step of determining whether the color is good or bad, when it is determined that the change of the color satisfies a predetermined condition, the colored optical fiber starts to be wound up as a non-defective product.

11. An apparatus for manufacturing a colored optical fiber, the apparatus comprising:
a tank that feeds colored resin into a die;
the die through which a coated optical fiber passes such that the colored resin is applied to a periphery of the coated optical fiber;
a sensor that detects a color of a colored layer formed of the colored resin on the periphery of the coated optical fiber; and
a controller that determines whether the color detected by the sensor is good or bad.
